(19) United States
(12) Patent Application Publication
(10) Pub. No.: US 2019/0152261 A1
(43) Pub. Date: May 23, 2019

(54) COMMERCIAL VEHICLE TYRE

(71) Applicant: Continental Reifen Deutschland GmbH, Hannover (DE)

(72) Inventors: Volkmar Fries, Wedemark (DE); Martijn Oosterbaan, Hannover (DE); Michael Schunack, Hannover (DE)

(73) Assignee: Continental Reifen Deutschland GmbH, Hannover (DE)

(21) Appl. No.: 16/098,184

(22) PCT Filed: Feb. 20, 2017
(86) PCT No.: PCT/EP2017/053754

§ 371 Date: Nov. 1, 2018

(30) Foreign Application Priority Data
May 3, 2016 (DE) 10 2016 207 561.6

(51) Int. Cl. B60C 9/00; D07B 1/06

(52) U.S. Cl. CPC B60C 9/0007; B60C 2009/0466; D07B 1/062

(57) ABSTRACT

A commercial vehicle tire of a radial type of construction with a cross-sectional height of 135 mm to 200 mm, a load index of 121 to 154, a radial-ply casing with at least one casing ply composed of steel cords embedded in rubber and with bead regions with bead cores and bead fillers around which the casing ply runs so as to form turn-ups. The casing ply is reinforced with steel cords of the construction 1+6, wherein the core filament (1) has a diameter (d₁) of 0.19 mm to 0.22 mm and the ply filaments (2) have coinciding diameters (d₂) of 0.17 mm to 0.20 mm, wherein the diameter (d₂) of the ply filaments (2) is less than the diameter (d₁) of the core filament (1) by at least 0.01 mm and wherein, at the crown of the tire, the steel cords are arranged in the casing ply with 60 epdm to 75 epdm.

The invention relates to a commercial vehicle tire of a radial type of construction with a cross-sectional height of 135 mm to 200 mm, a load index of 121 to 154, a radial-ply casing with at least one casing ply composed of steel cords embedded in rubber and with bead regions with bead cores and bead fillers around which the casing ply runs so as to form turn-ups.

It is usual in commercial vehicle tires of the type mentioned at the beginning—with a cross-sectional height of 135 mm to 200 mm and a load index of 12 to 154—to reinforce the casing ply with steel cords of the construction 3×0.20 mm+9×0.175 mm, wherein the steel filaments have a tensile strength in the NT range of 2700 N/mm² to 3050 N/mm² and, at the crown of the tire, are arranged with 30 to 45 epdm. Although the steel cords impart good strength properties to the casing ply, they have the disadvantage that, when molding the completely built tire blank into the vulcanizing mold, it can happen that the steel cords are pressed through the inner layer in the shoulder regions of the tire.

A commercial vehicle tire that is a light truck tire is known from U.S. Pat. No. 6,719,030 B2. In the case of this tire, the casing turn-ups are brought back to the casing ply, designed as a single ply, running directly around the bead cores, so that no bead fillers are provided radially outside the bead cores. Steel cords of various constructions are mentioned for use as reinforcing elements in the casing ply, including the construction 1+6, wherein the filaments can have a tensile strength of at least 2500 N/mm² and their diameter can be 0.15 mm to 0.30 mm, preferably 0.17 mm to 0.22 mm.

The invention is based on the object of designing a commercial vehicle tire of the type mentioned at the beginning in such a way that the casing ply, while having good strength properties, is reinforced with steel cords such that pressing-through of the steel cords in the shoulder regions of the tire during molding into the tire vulcanizing mold no longer occurs.

The stated object is achieved according to the invention by the casing ply being reinforced with steel cords of the construction 1+6, wherein the core filament has a diameter of 0.19 mm to 0.22 mm and the ply filaments have coinciding diameters of 0.17 mm to 0.20 mm, wherein the diameter of the ply filaments is less than the diameter of the core filament by at least 0.01 mm and wherein, at the crown of the tire, the steels cords are arranged in the casing ply with 60 epdm to 75 epdm.

It has been found that, in a commercial vehicle tire with a cross-sectional height of 135 mm to 200 mm and a load index of 121 to 154, to obtain good strength properties of the casing ply (plies), it is particularly advantageous to use 1+6 steel cords with filaments that have diameters in the ranges mentioned. The coordination performed according to the invention of the steel cords used, in terms of their mutual spacing in the casing ply, is particularly advantageous. The mutual spacing of the steel cords is smaller in the green tire than in the vulcanized tire, which in addition to the special construction of the steel cords contributes to avoiding pressing through of the steel cords in the shoulder regions of the tire during the molding into the tire vulcanizing mold. It has additionally been found that commercial vehicle tires designed according to the invention have a greater puncture resistance in the belt/tread region than known designs.

In the case of a preferred embodiment of the invention, the diameter of the ply filaments is less than the diameter of the core filament by at least 0.02 mm.

Depending on the size of the commercial vehicle tire and the load index, it is advantageous to use steel filaments of specific strength classes. The filaments may therefore consist of steel of strength classes NT, HT or SHT. Particularly preferred is a design of the filaments with a tensile strength of at least 3200 N/mm².

Also preferred is a design in which the ply filaments are twisted around the core filament with a length of lay of 10.0 mm to 14.0 mm, in particular of 12.5 mm.

Also preferred is a steel cord construction in which the core filament has a diameter of 0.20 mm and the ply filaments each have a diameter of 0.175 mm. The use of such steel cords especially, together with an arrangement at specific mutual distances, is suitable particularly well for preventing steel cords from being pressed through in the shoulder regions of the tire during the molding into the tire vulcanizing mold.

Further features, advantages and details of the invention are now described in more detail on the basis of the single FIGURE,

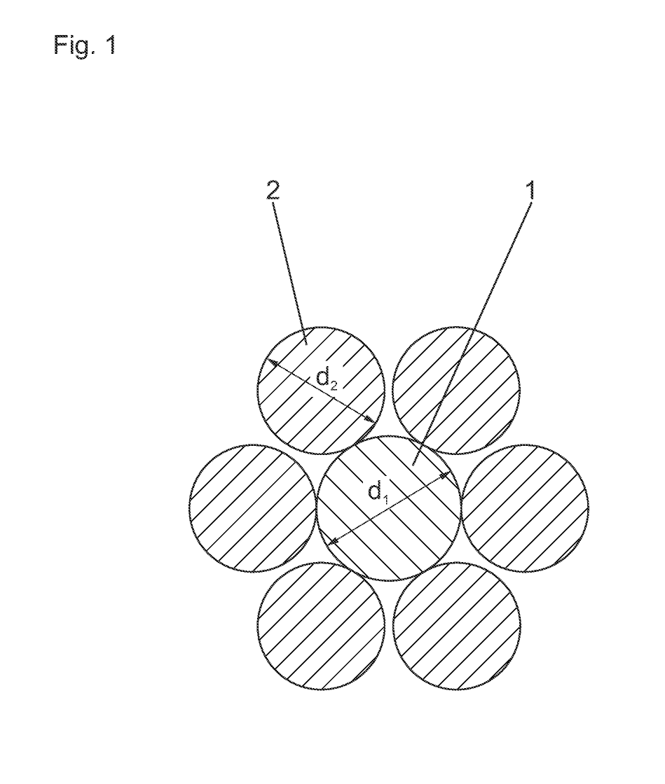

FIG. 1, which schematically shows a cross section of a design variant of a steel cord intended for a casing ply of a commercial vehicle tire.

A commercial vehicle tire designed according to the invention is a commercial vehicle tire of the radial type of construction with a cross-sectional height of 135 mm to 200 mm and a load index of 121 to 154. The commercial vehicle tire has the usual components, such as a profiled tread, a multi-ply breaker belt assembly, in particular reinforced with steel cords, an inner layer, bead regions with bead cores and bead fillers and also a radial-ply casing comprising at least one casing ply reinforced with steel cords. The steel cords of the casing ply run in the radial direction in the sidewalls, in the axial direction radially inside the tread and the breaker belt.

FIG. 1 shows a cross section of a steel cord particularly suitable for use in the casing ply of commercial vehicle tires designed according to the invention, which has the construction 1+6 and accordingly comprises a single core filament 1 and six ply filaments 2 in contact with the outer side thereof. The ply filaments 2 are twisted in a way known per se in the S or Z direction around the core filament 1, with a length of lay of 10.0 mm to 14.0 mm, preferably of approximately 12.5 mm.

The core filament 1 and the ply filaments 2 consist of steel of strength classes NT (normal tensile), HT (high tensile) or SHT (super high tensile). Steel filaments of the strength class NT have a tensile strength of 2700 N/mm² to 3050 N/mm², steel filaments of the strength class HT have a tensile strength of 3050 N/mm² to 3330 N/mm² and steel filaments of the strength class SHT have a tensile strength of 3350 N/mm² to 3650 N/mm². In the case of a preferred design, the filaments 1, 2 have a tensile strength of at least 3200 N/mm².

The core filament 1 and the ply filaments 2 each have a substantially circular cross section. The core filament 1 has a diameter d₁ of 0.19 mm bis 0.22 mm, preferably of 0.20 mm. All of the ply filaments 2 have coinciding diameters d₂ of 0.17 mm to 0.20 mm, in particular of 0.175 mm, wherein the diameter d₂ of the ply filaments 2 is less than the diameter d₁ of the core filament 1 by at least 0.01 mm, preferably by at least 0.02 mm. In the case of a preferred design, the steel cord has a core filament 1 with a diameter d₁ of 0.20 mm and six ply filaments 2 with a diameter d₂ of 0.175 mm.

For producing a casing ply comprising such steel cords, the steel cords are embedded in one of the usual rubberizing mixtures by calendering, wherein the number of steel cords in the unvulcanized calendered casing ply is 90 epdm to 120 epdm (ends per decimeter).

In the vulcanized commercial vehicle tire as a finished product, the number of steel cords at the crown of the tire or along the equatorial plane of the tire is 60 epdm to 75 epdm, depending on the size of the tire.

### LIST OF REFERENCE NUMERALS

1 . . . Core filament
2 . . . Ply filament
d₁, d₂ . . . Diameter

1.-6. (canceled)

7. A commercial vehicle tire of a radial type of construction with a cross-sectional height of 135 mm to 200 mm, a load index of 121 to 154, a radial-ply casing with at least one casing ply composed of steel cords embedded in rubber and with bead regions with bead cores and bead fillers around which the casing ply runs so as to form turn-ups;
wherein the casing ply is reinforced with steel cords of the construction 1+6, and comprised of a core filament and ply filaments, wherein the core filament has a diameter (d1) of 0.19 mm to 0.22 mm and the ply filaments have coinciding diameters (d2) of 0.17 mm to 0.20 mm;
wherein the diameter (d2) of the ply filaments is less than the diameter (d1) of the core filament by at least 0.01 mm; and,
wherein, at the crown of the tire, the steel cords are arranged in the casing ply with 60 epdm to 75 epdm.

8. The commercial vehicle tire as claimed in claim 7, wherein the diameter (d2) of the ply filaments is less than the diameter (d1) of the core filament by at least 0.02 mm.

9. The commercial vehicle tire as claimed in claim 7, wherein the core filament and the ply filaments have a tensile strength of at least 3200 N/mm².

10. The commercial vehicle tire as claimed in claim 7, wherein the ply filaments are twisted around the core filament with a length of lay of 10.0 mm to 14.0 mm.

11. The commercial vehicle tire as claimed in claim 10, wherein the length of lay is 12.5 mm.

12. The commercial vehicle tire as claimed in claim 7, wherein the core filament has a diameter (d1) of 0.20 mm and the ply filaments have a diameter (d2) of 0.175 mm.
